(19) United States
(12) Patent Application Publication
(10) Pub. No.: US 2026/0185955 A1
(43) Pub. Date: Jul. 2, 2026

(54) SYSTEM AND METHOD FOR MODELING OF PROPAGATION OF THERMAL RUNAWAY IN SOLID-STATE BATTERIES

(71) Applicant: Solid Power Operating, Inc., Louisville, CO (US)

(72) Inventors: Omar A. CHAARAWI, Boulder, CO (US); Stephanie B. Young, Louisville, CO (US); Clint R. Bickmore, Louisville, CO (US); Forrest A.L. Laskowski, Bend, OR (US); Rose E. Ruther, Lafayette, CO (US)

(21) Appl. No.: 19/438,252

(22) Filed: Dec. 31, 2025

Related U.S. Application Data
(60) Provisional application No. 63/740,739, filed on Dec. 31, 2024.

(51) Int. Cl. G01N 25/48; G05B 13/04; H01M 10/42

(52) U.S. Cl. CPC G01N 25/488; G05B 13/042; H01M 10/4285

(57) ABSTRACT

A system and method for characterizing a susceptibility of part of a battery to thermal runaway. The method includes determining a first set of parameters of the part of the battery, the first parameters representing a chemical composition of the part of the battery, a dimension of the part of the battery, and a micro-structure of the part of the battery; and applying the first parameters to a thermal model of the part of the battery to determine second parameters, the thermal model simulates a runaway thermal event, and the second parameters include a heat of reaction, an activation energy, or an Arrhenius pre-factor. Further, the method includes obtaining measurements of a sample of the part of the battery; and analyzing the measurements together with the second parameters to determine the susceptibility of the part of the battery to thermal runaway.

### CROSS-REFERENCE TO RELATED APPLICATION

This application is related to and claims priority under 35 U.S.C. § 119(e) from U.S. Patent Application No. 63/740,739 filed Dec. 31, 2024, titled “Thermal Propagation of Thermal Runaway in Solid-State Batteries,” the entire contents of which is incorporated herein by reference for all purposes.

### TECHNICAL FIELD

This disclosure relates to the field of electrochemical batteries and, in particular, this disclosure relates to systems and methods for testing and/or predicting thermal runaway in a solid-state electrochemical device.

### BACKGROUND AND INTRODUCTION

Rechargeable batteries are ubiquitous and are used to provide electrical power countless devices including scooters, e-bikes, mobile computing devices, grid storage arrays, and hybrid and full electric vehicles. Solid-state batteries (SSBs) are a promising next-generation energy storage technology that differs from conventional lithium-ion (Li-ion) batteries by replacing the liquid electrolyte with a solid electrolyte. This change could potentially solve several limitations of conventional liquid electrolyte type batteries, such as safety risks, energy density, and longevity. The basic structure of a solid-state battery includes three main components: a cathode; an anode, and a solid electrolyte, sometimes referred to as a separator. For example, when the battery uses a positive ion as the charge carrier, the cathode is the positive electrode where positive ions are transferred to during discharge, and the anode is the negative electrode where positive ions are released during discharge. The solid electrolyte is a solid material that facilitates the movement of the ions between the cathode and anode during charge and discharge cycles and serves as a separator between the anode and cathode.

SSBs have several advantages. Traditional lithium-ion batteries use liquid electrolytes that increase flammability and pose a risk of thermal runaway, fire, or explosion in the event of damage or overheating of the battery. Solid-state batteries, by contrast, use solid electrolytes that are non-flammable, reducing the risk of fires or chemical leaks. Solid-state batteries have the potential to offer higher energy density than conventional lithium-ion batteries. For example, solid electrolytes can allow for the use of lithium metal anodes instead of the conventional graphite anodes used in Li-ion batteries. Lithium metal has a much higher theoretical capacity than graphite, which could enable solid-state batteries to store more energy in the same volume, leading to smaller and lighter batteries. This increased energy density can significantly enhance the performance of devices such as electric vehicles (EVs, drones, and portable electronics), where longer battery life or range is beneficial.

Solid-state batteries may have a longer cycle life compared to lithium-ion batteries. The absence of liquid electrolytes and the use of stable solid materials could reduce wear and tear on the electrodes, potentially allowing these batteries to last many more charge-discharge cycles without significant degradation. Solid-state batteries can function effectively over a wider temperature range. The solid electrolyte is generally less susceptible to freezing or boiling, unlike liquid electrolytes that have a narrow operating window, making SSBs appealing for use in extreme environments. Solid-state batteries may also enable the development of thinner and more compact battery designs, because the solid electrolyte can be engineered to be much thinner than its liquid counterpart.

Thermal runaway is a challenge that can cause failures in many battery types including SSBs. Thermal runaway is a process where an increase in temperature leads to a self-perpetuating cycle that further accelerates the temperature rise, potentially resulting in dangerous outcomes. The process occurs when the heat generated by a system (e.g., a battery) exceeds the heat dissipated to the environment, causing a feedback loop. In the case of batteries, this can escalate into situations like fires.

It is with these observations in mind, among others, that aspects of the present disclosure were conceived.

### SUMMARY

Aspects of the present disclosure involve a method for manufacturing of a battery. The method may include the operations of causing a thermal reaction on a sample of a portion of the battery, obtaining measurements of the thermal reaction on the sample of the portion of the battery, wherein obtaining the measurement of the thermal reaction comprises a visual measurement of a rate of propagation of the thermal reaction of at least two points of the sample, and altering, based on the measurement of the thermal reaction on the sample, a thermal model simulating a runaway thermal event to determine a susceptibility of the portion of the battery to thermal runaway. The method may further include the operations of determining a first set of parameters of a portion of the battery, each of the first parameters corresponding to a physical property of the portion of the battery, applying the first parameters to the thermal model to determine a second set of parameters, and adjusting, based on the second set of parameters from the thermal model, at least one of the first set of parameters of the battery.

Another aspect of the present disclosure involves a system for manufacturing a battery. The system may comprise a testing apparatus for causing a thermal reaction on a sample of a portion of the battery comprising an igniter device for instigating the thermal reaction on the sample and a visual measurement device measuring a rate of propagation of the thermal reaction of at least two points of the sample. The system may also include a computing device comprising a processor and a memory comprising instructions that, when executed, cause the processor to alter, based on the measurement of the thermal reaction on the sample, a thermal model simulating a runaway thermal event to determine a susceptibility of the portion of the battery to thermal runaway, determine a first set of parameters of a portion of the battery, each of the first parameters corresponding to a physical property of the portion of the battery, and apply the first parameters to the thermal model to determine a second set of parameters, wherein the at least one of the first set of parameters of the battery is adjusted based on the second set of parameters from the thermal model.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 illustrates a battery material sample undergoing thermal runaway testing to calculate and observe of the rate of thermal propagation during the experiment according to the present disclosure.

FIG. 2 illustrates a plot of measured temperature at a point on the sample over time according to the present disclosure.

FIG. 3 shows an example sample of battery material used in the experiment to determine thermal runaway properties of the sample according to the present disclosure.

FIGS. 4A-4C show various views of an apparatus for measuring thermal runaway in battery samples according to the present disclosure.

FIGS. 5A-5F show Fourier transform infrared (FT-IR) spectra from measurement a gaseous by-products from thermal runaway tests of a sample of a battery part events according to the present disclosure.

FIG. 6 is a table illustrating parameters and inputs used for modeling a thermal event in a sample of battery material according to the present disclosure.

FIG. 7 illustrates a graph of the temperature at a point of a sample over time during a first parametric sweep of a first variable of a thermal model according to the present disclosure.

FIG. 8 illustrates a graph of the temperature at a point of a sample over time during a first parametric sweep of a second variable of a thermal model according to the present disclosure.

FIG. 9 illustrates a graph for estimated temperature measurements at two points of a battery material sample according to the present disclosure.

FIG. 10 is a graph illustrating a determined temperature at two points of a sample with parameter values of Hᵣₓₙ is 200 kJ/mol and k is 0.5 1/s according to the present disclosure.

FIG. 11 illustrates a comparison of results from the thermal propagation model executed with parametric sweeps discussed above as compared with an experimental result according to the present disclosure.

FIG. 12 is a graph illustrating Differential Scanning Calorimetry (DSC) fitting results of experimental results to model results according to the present disclosure.

FIG. 13 illustrates a heat profile parameter for a lighter source of a thermal runaway model according to the present disclosure.

FIG. 14 is a graph illustrating a k value at two points of a sample during modeling of a thermal runaway event according to the present disclosure.

FIG. 15 is a graph illustrating temperature values at two points of a for updated thermal runaway model with Arrhenius equation and lighter off function according to the present disclosure.

FIG. 16 shows a single point temperature validation for updated model as compared to an experimental result according to the present disclosure.

FIG. 17 shows the average values for temperature over time for various experiments for two points of a sample according to the present disclosure.

FIG. 18 includes a graph illustrating parameter estimation results and the improvement in the model accuracy according to the present disclosure.

FIG. 19 is a flowchart of an example method for altering a battery component based on a thermal runaway test of a sample of the component and a thermal runaway model according to the present disclosure.

FIG. 20 shows a computing device according to the present disclosure.

### DETAILED DESCRIPTION OF ILLUSTRATED EMBODIMENTS

Various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In this disclosure, the terms “including,” “containing,” and/or “having” are understood to mean comprising, and are open ended terms.

In this disclosure, unless otherwise specified, the term “metal” refers to metalloids, transition metals, or post-transition metals, and alloys or mixtures thereof. The term “metal” does not refer to alkali metals.

Aspects of this disclosure are directed to a system and method for characterizing batteries and battery materials for use in batteries to predict and/or mitigate thermal runaway. Additionally, the systems and methods can be used for quality control/assurance in the domain of thermal runaway for batteries and/or parts of the battery (e.g., the cathode). The system and method can be used, for example, to develop or create a battery to help ensure the safety of an all-solid-state battery (ASSB) by mitigating the risk of thermal runaway. Various examples discussed herein refer to an all-solid-state battery meaning that the electrodes and electrolyte are considered to be in a solid state, as opposed to example a battery having a liquid electrolyte. Aspects of the disclosure, however, are not limited to solid-state batteries.

The term “battery” in the art and herein can be used in various ways and may refer to an individual cell having an anode and cathode separated by an electrolyte, which may be a solid electrolyte, as well as a collection of such cells connected in various arrangements. A solid-state electrolyte cell may include more than one anode and cathode, separated by solid electrolyte layers, and may be encased within a flexible “pouch” that accommodates the expansion and contraction of the anode(s) and cathode(s) as the cell charges and discharges. Although many examples are discussed herein as applicable to a battery or a discrete cell, it should be appreciated that the systems and methods described may apply to many different types of batteries, battery chemistries, and may range from an individual cell to batteries involving different possible interconnections of cells such as cells coupled in parallel, series, and parallel and series. The electrodes (e.g., the cathodes and anodes) are in conductive communication with terminals or tabs that extend outside the pouch to enable electrical coupling of the battery to a battery terminal and/or to a circuit connecting multiple battery cells.

The apparatus and methods disclosed herein provide analysis and measurements of the reaction propagation rate of a sample of an ASSB component after undergoing thermal abuse to aid in prediction of such reactions in a constructed battery. In one method, the sample of the ASSB component is placed in a stand and heated while under analysis. The component can be a cathode, anode, separator, or any combination thereof, including an operative battery cell. For an assembled operative battery, the state of charge (SOC) of the sample of the battery component may be anywhere from 0 to 100%, or some other threshold. In many instances a solid-state battery is composed of planar layers of electrodes, and separators along with current collectors. Thus, a sample may be planar and may be cut to some specific size. The sample can be carefully measured in advance and the geometry can be regular. The sample then undergoes thermal abuse (e.g., one end of the sample is exposed and is connected to an electrode of a plasma arc lighter simulating an electrical short at the connection point (or points) of the electrode (or electrodes)) until a self-sustaining reaction is observed, which then propagates across the length of the sample and is imaged by an IR camera. The IR camera or other visual-capturing device having a sufficient sampling rate or frame rate (e.g., the rate can be 60 Hz or greater) and a sufficient resolution (e.g., 240×320 pixels or greater) may be used such that imaging the specimen across its length may occur sufficiently to capture a reaction, and preferably a plurality of images during a reaction, and otherwise based on the speed of reaction across the sample of the battery component. The experiment is repeated to generate a sufficient sample size (e.g., 10 sets of images capturing 10 propagations of reactions initiating at the connection point of 10 battery sample). Next the data is analyzed to determine the propagation rate of the reaction.

According to one implementation, the data may be analyzed in the following way. First a line is drawn within the captured image of the thermal reaction (e.g., the IR images) that is normal to the propagation of the reaction. For example, the thermal reaction may spread from an ignition point on the sample through the sample. As such, the ignition point may be located on an edge of the sample such that the line may extend from the ignition point along the sample normal to the direction of propagation of the thermal reaction. In addition, a length of the line may be determined by counting pixels corresponding to the line length within the captured image or images of the thermal reaction and normalizing the distance based on the known dimensions of the sample. In some instances, the line length may extend from the ignition point to an end point of the sample. In another example, as the length of the sample is known, any distance within the images corresponding to the length of the sample may be used to determine the length of the line. After drawing a line normal to the propagation of the reaction, one or more reference pixels may be selected along the line. A measured temperature at the reference points may be plotted with respect to time, with a maximum temperature set at Tₘₐₓ. Time is recorded for both points at ½ Tₘₐₓ. A delta time may then be determined to find how long it took for the reaction to propagate from the first point to the second point Since the distance between the points was previously determined, calculating the rate of propagation may be a distance between the points divided by delta time.

In this manner, an aspect of the present disclosure involves a method that allows for the accurate measurement of the reaction propagation rate of a sample of an ASSB component after undergoing thermal abuse. Understanding the reaction propagation rate addresses or may be used to address any number of challenges including the following challenges. In general, the propagation rate is an abstraction of the kinetics of the reactions that occur due to thermal runaway in the sample. Determining kinetics by other methods, such as the Kissinger Method coupled with Differential Scanning Calorimetry (DSC), is challenging and makes many assumptions regarding areas, such as reaction order. In contrast to existing techniques, the system and method disclosed herein enable a technique that allows for rapid screening of samples smaller than 1 gram. The apparatus discussed below may be configured in minutes and the whole experiment/analysis conducted in under an hour. Cleanup is also fast and several experiments conducted in a single day. Techniques like bomb calorimetry, accelerated rate calorimetry, or nail penetration tests generally require hours of setup and cleanup or require larger sample sizes—e.g., a fully constructed battery cell as opposed to separate components of a battery cell like an anode, cathode or separator layer. The disclosed apparatus also allows for immediate confirmation that reaction was successfully initiated.

As noted above, the system and method disclosed herein may also provide an apparatus for initiating a reaction in a sealed, transparent vessel so that the contents may be collected for analysis. The transparency of the vessel allows for visual confirmation that the reaction was initiated and completed. Further, as thermal runaway may be characterized by very high heat associated with an electrical short between oppositely charged electrodes, a slow reaction may produce various gases for analysis. Thus, the apparatus disclosed herein provides for a real-world device for gathering the various gases produced from thermal runaway of whatever battery component is being tested. In one implementation, the apparatus may include: a glass round bottom flask containing at least two ports, a device or devices to seal both ports, a plasma arc lighter mechanism which may be fed hermetically through one port, and a device that allows for the equilibration of pressure and may connect to either port also hermetically.

Gas analysis plays an important role in ASSB safety characterization and helping to iterate various electrode or other battery designs to, for example, optimize an electrode formulation. The systems and methods disclosed herein address deficiencies in prior techniques for gas analysis in support of a battery design. For example, there have been a lack of previous methods that allow for reliable initiation of thermal runaway events and capture of the evolved gasses at a small scale (e.g., less than one gram). Prior reaction vessels are often opaque, and confirmation of reaction is not readily obvious. The systems and methods disclosed herein thus provide reliable initiation of thermal runaway (TR)-like reactions that offer visual confirmation of reaction in a sealed vessel by using a transparent reaction vessel. The resulting gas and solid products can be characterized to better understand the reactions responsible for thermal runaway.

The temperature onset for thermal runaway has been studied using various techniques such as Differential Scanning Calorimetry (DSC), Thermogravimetric Analysis (TGA), and Simultaneous Differential Thermal Analysis (SDT), often at 100% state of charge (SOC). However, even when the reaction pathway is understood, employing and testing new chemistries (electrode compositions, separator compositions, and combinations of the same, among others) to find chemistries, and other aspects of new battery designs, that mitigate thermal runaway can be time consuming. It is difficult to know to what extent reaction kinetics can be reduced to slow or prevent thermal propagation such that trial and error testing is often the conventional approach. Also, conventional testing techniques (e.g. nail penetration) often require fabrication of full cells, which takes significant time and resources. In contrast, a comprehensive model based on testing of a small sample of an SSB can be used to evaluate the feasibility of slowing down the reaction kinetics of low-temperature reactions as a strategy to prevent thermal runaway in battery systems. A tool that can quickly evaluate how changes in chemistry affect propagation without necessitating full-cell builds would be advantageous and is at least one benefit from aspects of the present disclosure.

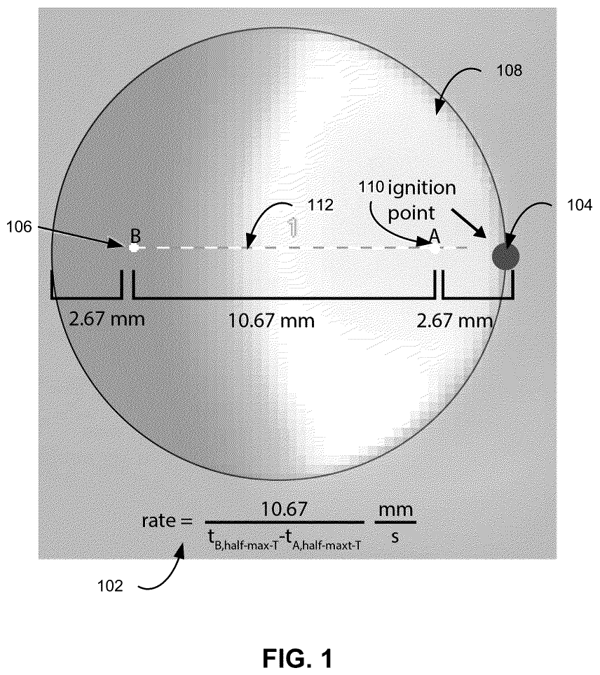

FIG. 1 illustrates the rate of thermal propagation across a sample 308, including the calculation of the rate of thermal propagation observed during a thermal runaway test described above. In particular, FIG. 1 illustrates a sample 108 of material that undergoes a thermal event at point 104. As described in more detail below, the thermal event may be caused by an arc lighter applied to the sample 108. Changes in the thermal properties of the sample 108 may propagate through the sample and a change in temperature at various points of the sample may be obtained, perhaps through a thermal camera device, and graphed. In some instances, a line 112 is drawn within the captured visuals that is normal to the propagation of the reaction. Further, a length of the line may be determined by counting pixels corresponding to the line length and normalizing the distance based on the known dimensions of the sample 108. After drawing the line 112 normal to the propagation of the reaction, one or more reference pixels may be selected along the line. For example, FIG. 1 illustrates the distance from the ignition point 104 of the sample 108 to a first point (point “A” 110) and a distance from point A to a second point (point “B” 106). The temperature of the sample 108 at point A 110 and at point B 106 may be used to determine the rate of thermal propagation, as illustrated in rate calculation 102. In general, FIG. 1 presents the data analysis that quantifies the rate at which various thermal parameters change, helping to understand the thermal dynamics involved.

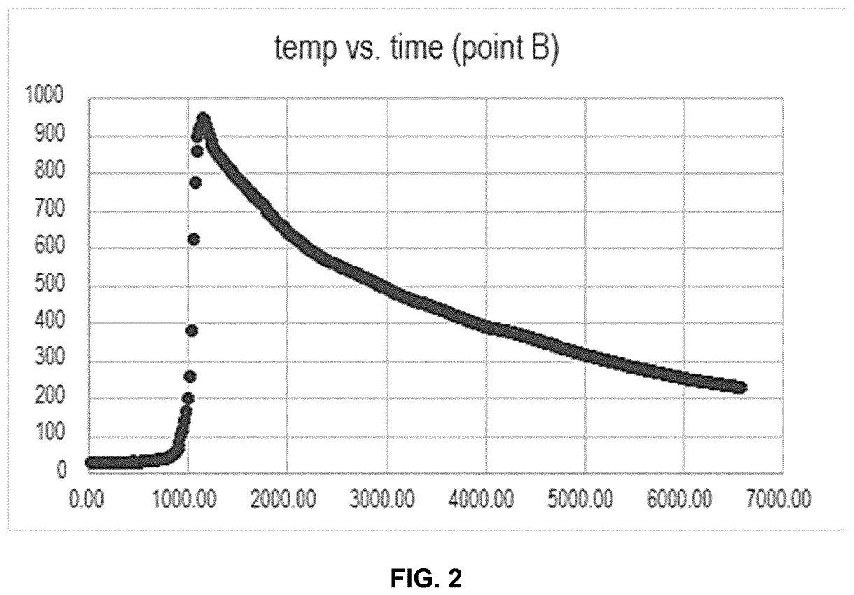

FIG. 2 shows the graphed change in temperature at point B 106 of the sample 108 over time. A similar graph may be generated for the change in temperature versus time of point A 110. The graphs may be utilized to determine the thermal propagation rate through the sample 108. In some instances, the graphs may be used for validation of a thermal runaway model discussed in more detail below as the graphs provide a direct comparison between the experimental temperature measurements and the temperatures predicted by the model. By aligning experimental data with model outputs, the accuracy and reliability of the model can be assessed and adjusted accordingly.

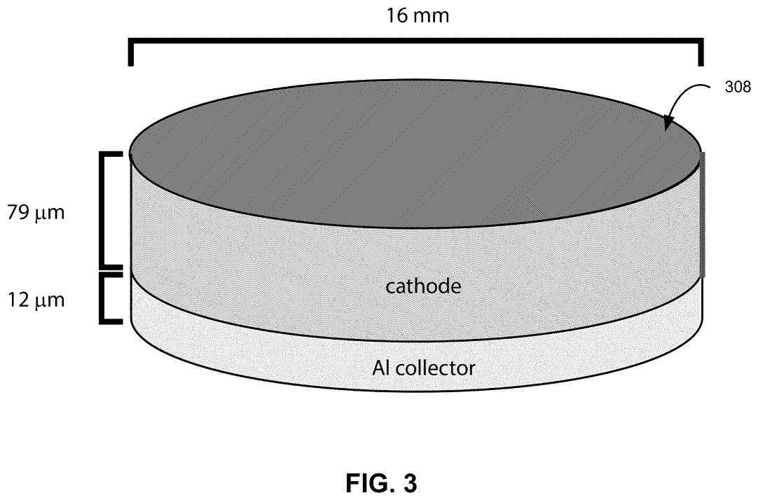

FIG. 3 shows a sample 308 that may be used for determining a thermal runaway propagation through the sample, as described above. As illustrated, the sample 308 may include a cathode layer and/or a collector layer. However, the sample 308 may include any layer or portion of a layer of a battery cell. For example, the sample 308 may include a current collector material in thin metal foils, such as copper or stainless steel. Electrode composites of the sample 308 may be, for example, a composite material including an active material made of silicon metal, a solid-state electrolyte material, a carbon-based conductive additive, and one or more polymers as binding agents. The composition of the electrode composites generally provides the composite with sufficiently high ionic and electronic conductivity to support rapid lithiation of the composite, especially a silicon-based material. Polymer(s) and/or binder(s) may be used to support the continued cohesion of the composite sample.

The electrode composite sample may generally include silicon or a compound thereof, a carbon-based conductive additive, solid electrolyte, and/or a binder material. Proportionally and in one example, the electrode composite may include at least 30% by weight of the silicon or the compound thereof; between 0% to 15% by weight of the carbon-based conductive additive; between 0% to 70% by weight of the solid electrolyte, and between 0% to 20% by weight of the binder. In an example electrode composite, the solid electrolyte may be completely absent leaving only active material (Si), conductive additive (carbon), and a binding agent (polymer/binder).

More specifically, the silicon or a compound thereof included in the electrode composite may include elemental silicon, silicon dioxide, coated silicon, and coated silicon dioxide. Coatings for the silicon or silicon compound may include carbon-based shells, oxide-based shells where the oxides are Al₂O₃, ZrO₂ or the like, and sulfide bases shells where the sulfides are Li₂S or sulfide electrolytes such as Li₃PS₄, Li₇P₃S₁₁, or Li₆PS₅Cl. As described herein, generation and persistence of the morphological modifications of the composite is a function of the volume expansion of the silicon-based material and the cohesive resilient properties of the binder. To support the volume expansion and similar chemical compatibility, other materials that exhibit a volume expansion similar to silicon may be substituted in place of silicon. Germanium (Ge) and Tin (Sn) undergo similar volume expansion through their lithiation process where Ge expands ˜280% and Sn expands ˜257%. These materials or other intercalation-based materials may be fully or partially substituted for the silicon-based material.

Binders or polymers useful for inclusion into the electrode composite may be one or more of a fluorine-containing binder such as polyvinylene difluoride (PVdF) and the like. In another embodiment, the binder may contain fluororesins such as vinylidene fluoride (VdF), hexafluoropropylene (HFP), tetrafluoroethylene (TFE), and derivatives thereof as structural units. Specific examples thereof include homopolymers such as poly (vinylene difluoride-hexafluoropropylene) copolymer (PVdF-HFP), polyhexafluoropropylene (PHFP) and binary copolymers such as copolymers of VdF and HFP. In yet another embodiment, the binder may be one or more selected from a thermoplastic such as but not limited to polystyrene, polyethylene, polypropylene, polycarbonate, and polyvinyl chloride. In a further embodiment, the binder may be one or more selected from a thermoplastic-elastomer such as but not limited to styrene-butadiene rubber (SBR), styrene butadiene styrene copolymer (SBS), poly(styrene-isoprene-styrene) copolymer (SIS), poly(styrene-ethylene-butylene-styrene) copolymer (SEBS) polyacrylonitrile (PAN), nitrile-butylene rubber (NBR), polybutadiene, polyisoprene, Poly (methacrylate) nitrile-butadiene rubber (PMMA-NBR) and the like. In yet another embodiment, the binder may be one or more selected from an acrylic resin such as but not limited to polymethyl (meth) acrylate, polyethyl (meth) acrylate, polyisopropyl (meth) acrylate polyisobutyl (meth) acrylate, polybutyl (meth) acrylate, and combinations thereof. Any specific binder or combination and its concentration within the composite may be adjusted to support generally uniform segmentation and fracture generation as well as long term cohesion of the composite under cycling to ensure electron/ion mobility. The binder selection also supports the adhesion of the composite to the current collector, and partially determines the rheological properties of the slurry.

The carbon-based conductive additive of the electrode composite may be one or more of vapor-grown carbon fiber (VGCF), carbon black, acetylene black, activated carbon, furnace black, carbon nanotube, Ketjen Black, graphite such as natural graphite or artificial graphite, and graphene. The carbon-based conductive additive works in conjunction with the solid electrolyte material to evenly distribute the charge density throughout the composite by regulating the distribution of electrons throughout the volume of the composite.

The solid electrolyte may be one or more of Li₂S—P₂S₅, Li₂S—P₂S₅—LiI, Li₂S—P₂S₅—LiBr, Li₂S—P₂S₅—LiCl, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZnSn (where m and n are positive numbers, and Z is Ge, Zn or Ga), Li₂S—GeS₂, Li₂S—S—SiS₂—Li₃PO₄, and Li₂S—S—SiS₂-LiₓMO_{y} (where x and y are positive numbers, and M is P, Si, Ge, B, Al, Ga or In). Specific exemplary electrolyte materials may be one or more of Li₃PS₄, Li₄P₂S₆, Li₆PS₇, Li₇P₃S₁₁, Li₁₀GeP₂S₁₂, Li₁₀SnP₂S₁₂. In another embodiment the electrolyte material may be one or more of Li₆PS₅Cl, Li₆PS₅Br, Li₆PS₅I or Li_{7-y}PS_{6-y}X_{y} where “X” represents at least one halogen elements and or pseudo-halogen and where 0<y≤2.0 and where the halogen may be one or more of F, Cl, Br, I, and a pseudo-halogen may be one or N, NH, NH₂, NO, NO₂, BF₄, BH₄, AlH₄, CN, and SCN. In yet another embodiment the electrolyte material may be one or more of a Li_{8-y-z}P₂S_{9-y-z}X_{y}W_{z} where “X” and “W” represents at least one halogen elements and or pseudo-halogen and where 0≤y≤1 and 0≤z≤1 and where a halogen may be one or more of F, C, Br, I, and a pseudo-halogen may be one or N, NH, NH₂, NO, NO₂, BF₄, BH₄, AlH₄, CN, and SCN. In yet a further embodiment, the electrolyte material may be one or more of a Li₄PS₄X, Li₄GeS₄X, Li₄SbS₄X, and Li₄SiS₄X where “X” represents at least one halogen elements and or pseudo-halogen and where a halogen may be one or more of F, C, Br, I, and a pseudo-halogen may be one or N, NH, NH₂, NO, NO₂, BF₄, BH₄, AlH₄, CN, and SCN. The solid electrolyte material, when mixed with a binder, may form a flexible matrix. The carbon additive and the silicon-containing material may then be suspended in this matrix. The flexible matrix provides the composite with the ability to maintain particle-to-particle contact while the silicon-containing material expands and contracts under cycling.

The measurements provided in FIG. 3 are but one example of a sample 308 that may be used. In this example, the arc lighter of the test discussed above may have an approximate area of 1-2 mm² and is positioned on the cathode material. To determine the boundary conditions, the arc's angle of 10 degrees is considered and a constant temperature boundary condition is applied to this arc. Typically, the maximum temperature reached by arc lighters is around 950° C. and can be assumed to be a fixed boundary condition.

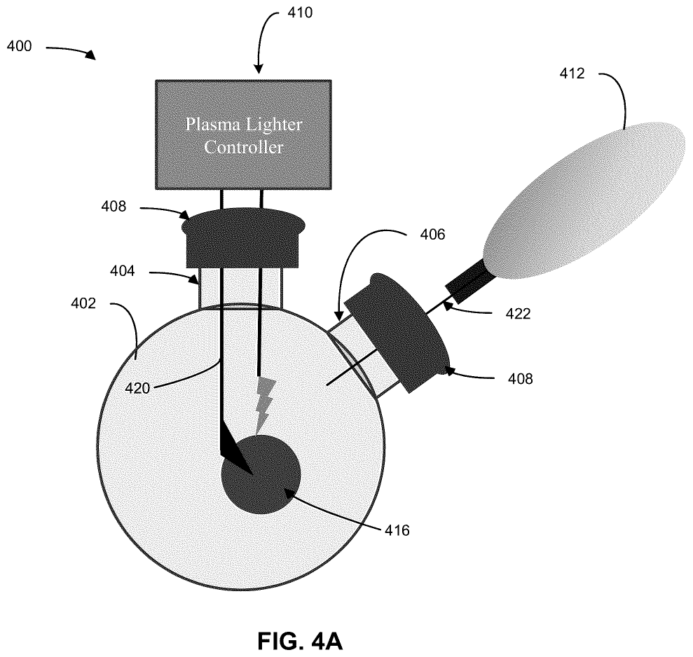

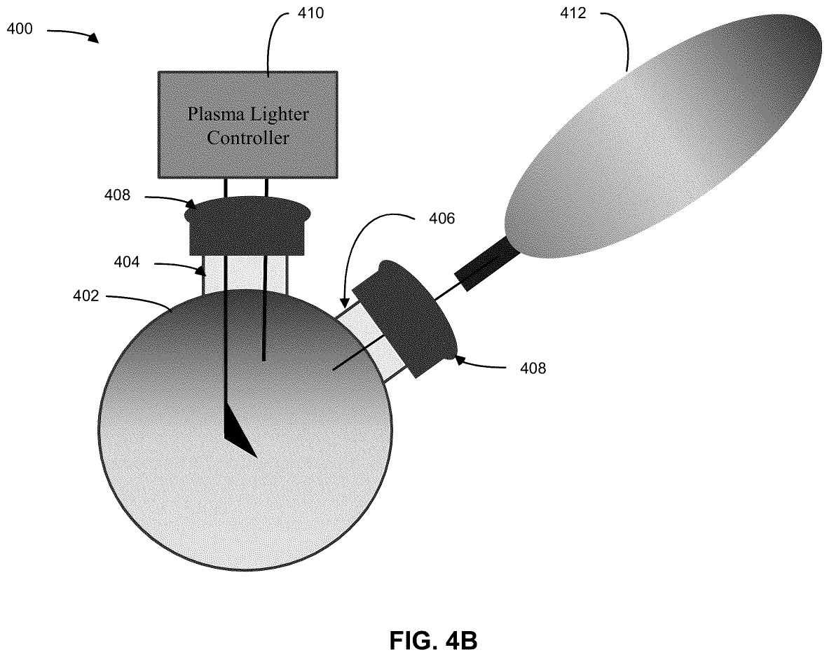

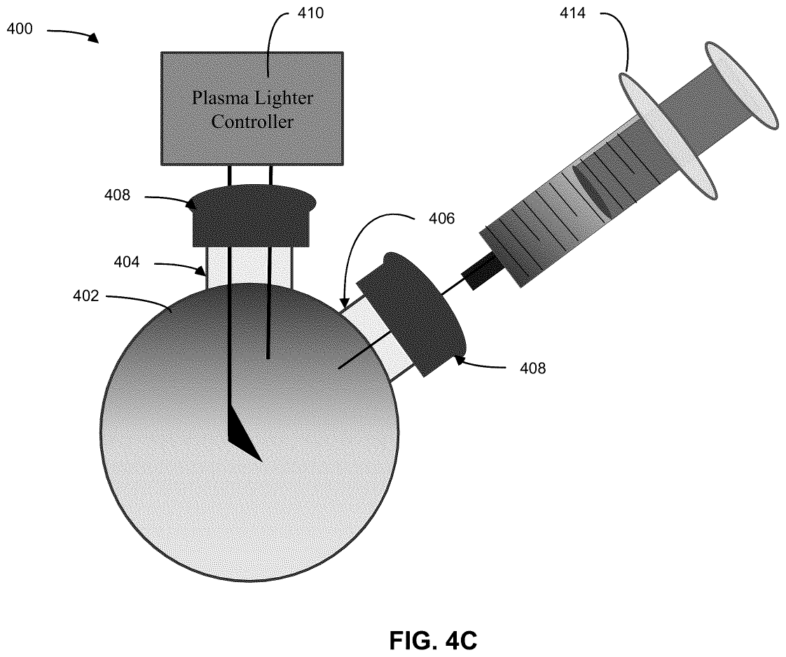

In some instances, an apparatus for initiating a reaction in a sealed, transparent vessel may be employed to determine the thermal runaway properties of the sample 308 and so that contents resulting from the testing may be collected for analysis. FIGS. 4A-4C illustrates various views of the apparatus 400 that includes a transparent round bottom flask 402 containing at least two ports 404, 406, a device or devices to seal both ports 408, a plasma arc lighter mechanism 410 which may be fed hermetically through one port, and a device 412 that allows for the equilibration of pressure and may connect to either port also hermetically. As illustrated in FIGS. 4A and 4B, the equilibration device 412 may include a balloon or, as illustrated in FIG. 4C, may include a syringe device 4134. A conductive sample 416 (up to 1 gram in some instances) may be placed within the flask 402 and connected to the plasma lighter mechanism 410. In one example, the specimen is fed through one port 404 of the flask 402, after which the port is sealed, such as by a rubber septa 408 with wires 420 fed through the seal. The wires 420 allow the connection to the plasma lighter mechanism 410 for the generation of plasma within the flask 402. Another device 412, which may be a balloon, is attached to a hypodermic needle 422 which is pierced through the other port 406 that has also been sealed with a rubber septa 408. The atmosphere within the vessel 402 may be controlled in a variety of ways depending on the specifications of the experiment. For example, the apparatus may be preloaded in an inert environment at ambient atmospheric pressure or a partial vacuum may be pulled on the vessel 402. Following configuration of the apparatus 400, the igniter is used to initiate the reaction within the flask 402 while the transparency of the vessel allows the user to confirm the reaction took place. A sample of the headspace gas may be collected through the balloon device 412 and analyzed by any instrument of choice. In addition, the apparatus 400 has the added benefit that any solids or liquids generated from the plasma reaction within the flask may be collected and analyzed. FIG. 4B shows the apparatus 400 before being loaded within a sample. As gases are generated from the plasma reaction within the flask 402, the balloon 412 may expand to equilibrate the pressure within the flask as gasses evolve. Any evolved gasses may also be collected for analysis. The syringe device 414 of FIG. 4C provides a similar equalization and collection mechanism for the apparatus 400.

The system and method disclosed herein provide several benefits over previous thermal runaway testing apparatus. For example, the apparatus 400 allows for high-throughput screening of gasses evolved during thermal runaway events with sample sizes of 1 gram or less, thereby providing small-scale testing. Further, the transparency of reaction vessel 402 allows for a qualitative determination of the reaction progress. Additionally, cleanup of the apparatus 400 following a test is relatively fast and the vessel may be prepared for additional experiments in minutes.

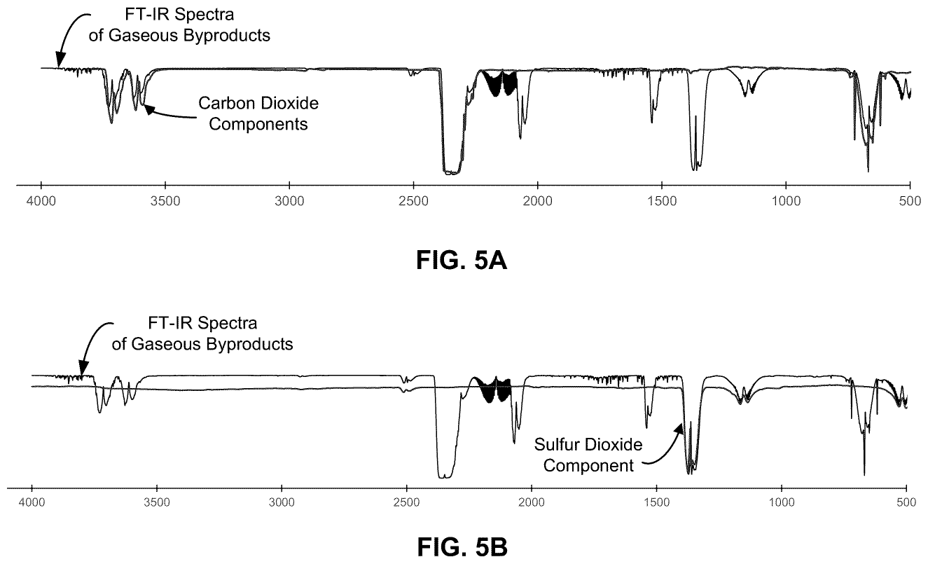

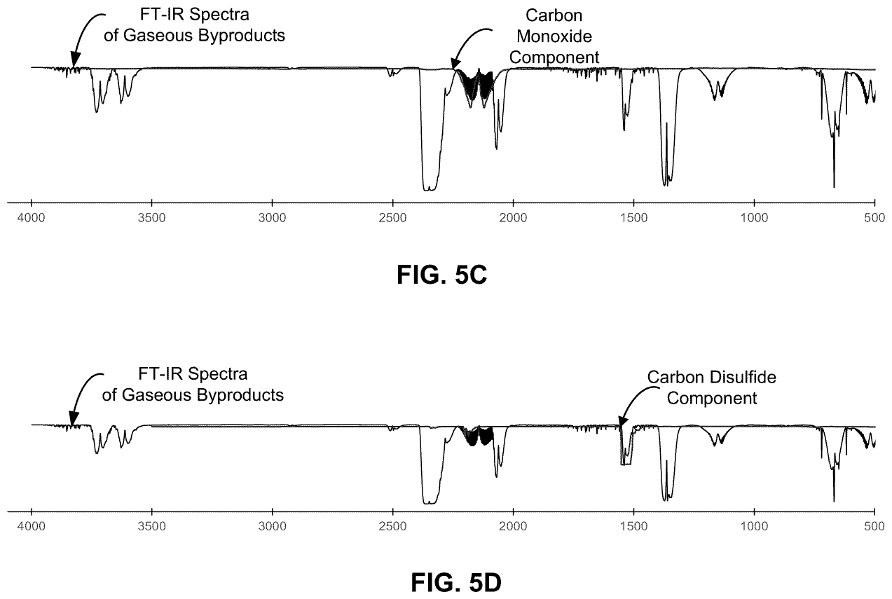

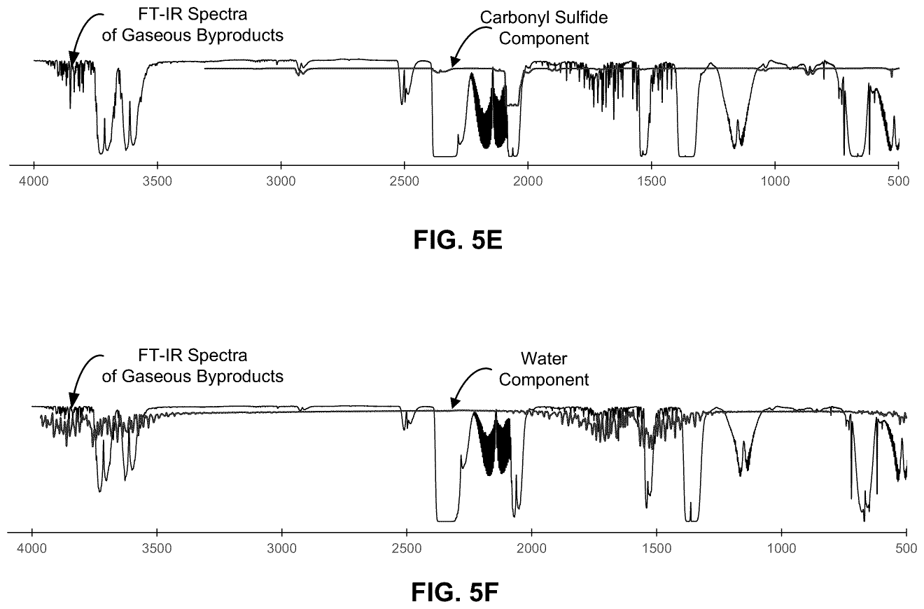

FIGS. 5A-5F illustrate Fourier transform infrared (FT-IR) spectroscopy graphs to determine the components of the gaseous effluence and byproducts resulting from the apparatus 400 discussed above. The IR signatures of various gases, such as carbon dioxide, sulfur dioxide, carbon monoxide, carbon disulfide, carbonyl sulfide, water, etc., can be used extract for the measured spectrum the amounts of the various constituents. This is a non-limiting example of a method for analyzing the by products from the apparatus. Other analysis methods can include X-ray photoelectron spectroscopy, Raman spectroscopy, gas chromatography, nuclear magnetic resonance (NMR), mass spectrometry (MS), X-ray diffraction (XRD), and inductively coupled plasma mass spectrometry (ICP-MS).

In some instances, the results of the thermal testing discussed above may be utilized to generate an arc lighter model, which has two primary purposes which solve the above problems. First, the model can be employed as a data analysis tool to quickly (e.g., less than one hour) calculate the enthalpy, Arrhenius prefactor, activation energy, and other aspects associated with an experimental arc lighter test. Second, the model can be used to screen the parameter space, to identify variable spaces where propagation no longer occurs. Reducing thermal runaway in batteries by controlling temperature without relying on experimental analysis, and achieving high-speed responses, can be effectively accomplished through this advanced computational modeling.

Further, the arc lighter model may be used to calculate parameters such as the heat of reaction, activation energy, and the Arrhenius pre-factor, which are used for understanding the thermodynamic and kinetic behavior of reactions under thermal stress. In general, the model is used in the context of a thermal propagation event induced by an arc lighter heat source. The test is designed to quickly evaluate thermal runaway events, which can be done at the electrode scale, without having to build full cells. In addition, modifications to the component of the battery and associated reaction kinetics can be assessed-such as slowing the rate of exothermic reactions—and the component for the final cell modified accordingly to effectively mitigate the risk of thermal runaway. This approach could provide a viable pathway to enhance the safety of modifications to various existing battery chemistries as well as design and test next-generation battery chemistries to improve their overall thermal stability.

In one implementation, a model is developed that integrates the experimental data determined through the method and apparatus above to evaluate parameters such as the heat of reaction, activation energy, the Arrhenius pre-factor, and the like. The model serves as a computational tool to simulate the thermodynamic and kinetic behavior of the system, allowing for accurate predictions of reaction dynamics under various conditions.

The arc lighter method described above is designed to evaluate the temperature dynamics during thermal runaway events, employing a thermal camera to capture detailed thermal data. This experimental data is useful for assessing and refining the accuracy of the computational model. The arc lighter model can also be used to screen cell designs with extra-carbon primer on the cathode current collector, as a specific example.

Performing parameter estimation for the heat of reaction, activation energy, and the Arrhenius pre-factor provides useful data for understanding the thermodynamic and kinetic properties of a chemical reaction. By accurately estimating these parameters, researchers can predict the reaction's behavior under various conditions. This enables more precise modeling of the reaction's rate and the energy released, which is used for assessing its safety and stability. Specifically, incorporating these estimations into the research and design process gives teams the ability to evaluate new formulations and predict their thermal runaway properties much faster and with lower cost rather than experimental study. This insight is useful for designing safer chemical composition, and identifying potential risks associated with thermal instability in new formulations. Thus, it enhances the ability to forecast and mitigate dangerous scenarios like uncontrolled temperature increases, which could lead to catastrophic failures.

The generation of the arc lighter model is now described using experimental analysis, for which the above-described method and apparatus may be utilized. In general, the arc lighter experiment is designed to evaluate the temperature dynamics during thermal runaway events, employing a thermal camera to capture detailed thermal data. This experimental data is useful for assessing and refining the accuracy of the computational model discussed above for use in determining battery chemistries. Reactions are applied to this model as a heat source to the whole domain of cathode material. In the definition of the heat source an onset temperature (T_{ONSET}), reaction rate constant (k) and heat of reaction (hᵣₓₙ) are defined. This model will thus consider the reactions and their rate whenever any cell in the cathode domain reaches onset temperature.

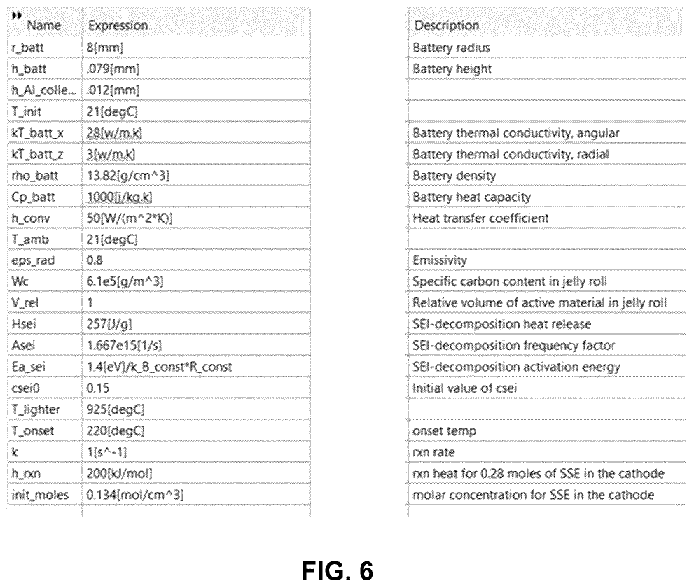

FIG. 6 shows one example of parameters and inputs used for the arc lighter model discussed above. However, it should be appreciated that various other parameters, inputs, values, etc. may be used. The heat of reaction represents the amount of heat released or absorbed per mole of reactant converted to product and may play a role in determining the magnitude of thermal runaway. For example, in many thermal runaway scenarios, the heat of reaction is large and the reaction is exothermic, meaning heat is continuously released as the reaction progresses, further accelerating the process.

For a general exothermic reaction:

$$A \to B with Δ {H}_{rxn} < 0$$

In which ΔHᵣₓₙ is the change in reaction heat. The rate of heat generation is related to the reaction rate r(T) by:

$${\dot{Q}}_{rxn} = - Δ {H}_{rxn} \cdot r ( T )$$

where r(T) is typically an Arrhenius-type function of temperature:

$$r ( T ) = A exp ( \frac{- {E}_{a}}{RT} )$$

where:
A is the pre-exponential factor,
Eₐ is the activation energy,
R is the gas constant,
T is the temperature.
   This equation illustrates the effect of temperature on the reaction rate, and as the temperature increases due to exothermicity, the rate of reaction accelerates, which further increases temperature, creating a positive feedback loop that can lead to thermal runaway.

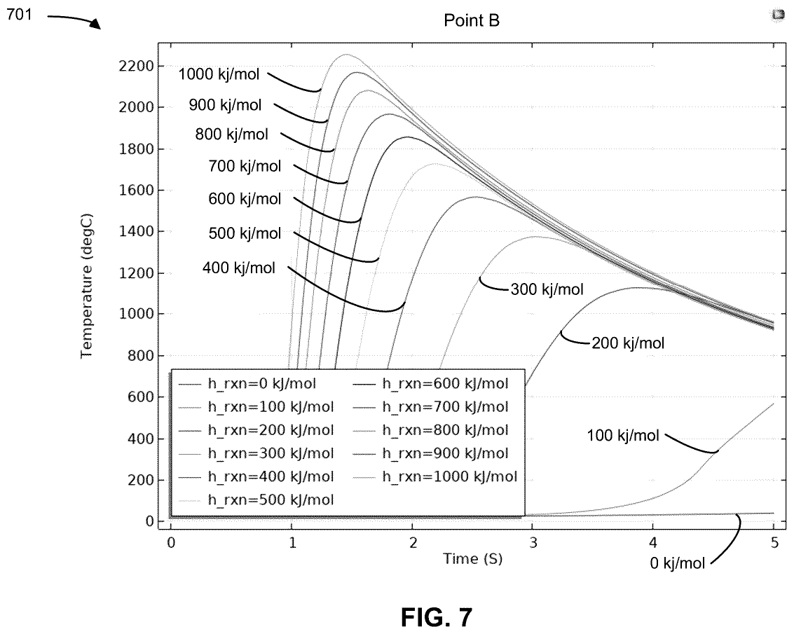

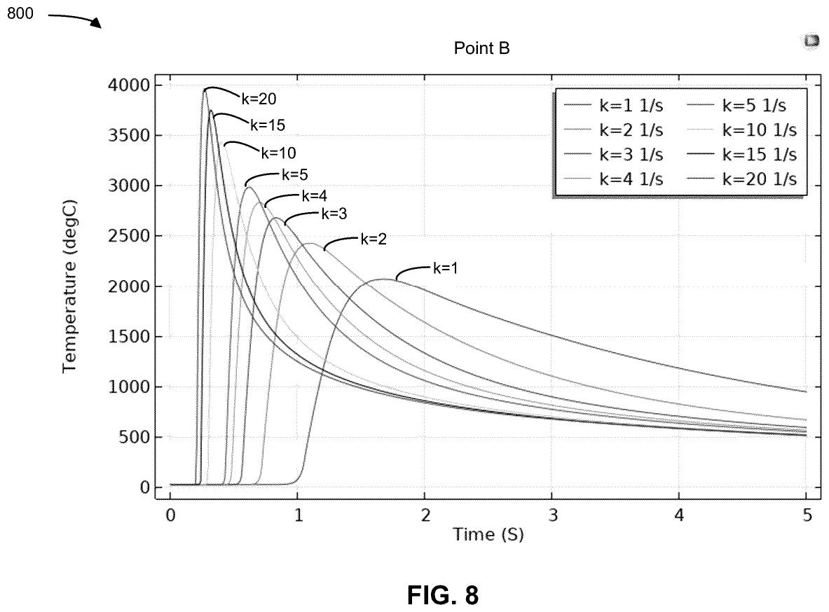

Parametric sweep studies for Hᵣₓₙ (reaction heat) and k (rection rate constant) may then be conducted. In one example, the parametric sweep may vary Hᵣₓₙ from 0 to 1000 in increments of 100 to explore a broad spectrum of possible values and their impact on the model. In general, these parametric sweeps allow for a thorough investigation of how changes in these parameters affect the thermal runaway. The results aid in understanding the sensitivity of the model to variations in for Hᵣₓₙ and k and are useful for fine-tuning the model and ensuring its accuracy under different operational conditions. FIG. 7 illustrates the results 701 of such a parametric sweep of the temperature at point B 306 of the sample 308 for a sweep of Hᵣₓₙ and FIG. 8 illustrates the results 800 of a parametric sweep of the temperature at point B of the sample for a sweep of k. As can be seen in these figures, by increasing Hᵣₓₙ the max temperature increases significantly which results in faster thermal runaway.

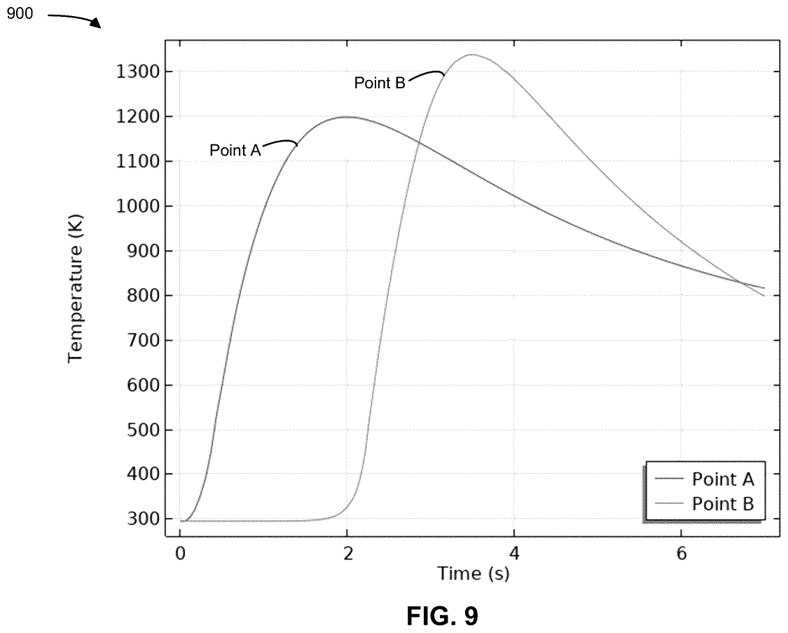

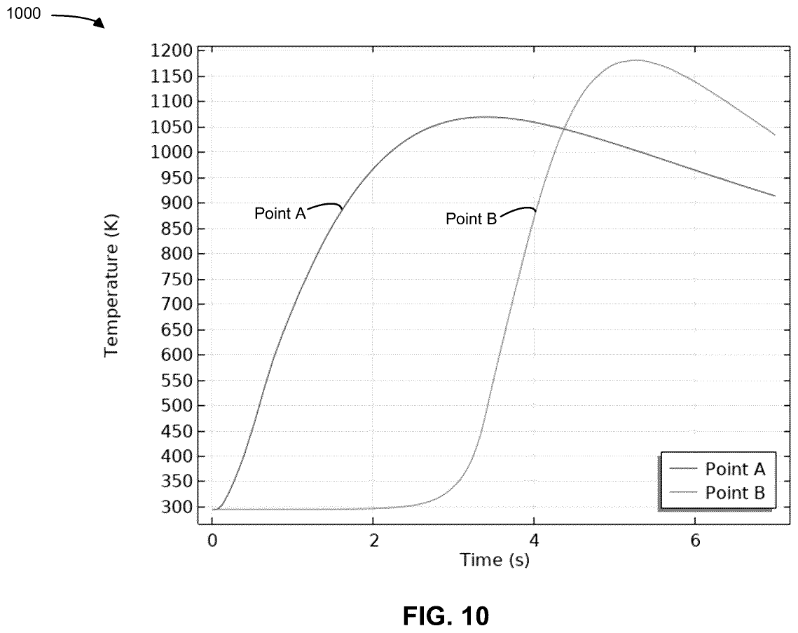

The difference in the effect of the k values on the sample 308 are illustrated in the graph 900 of FIG. 9 and the graph 1000 of FIG. 10. In particular, FIG. 9 is a graph 900 illustrating a determined temperature at point A 310 and point B 306 of the sample 308 with parameter values of Hᵣₓₙ at 200 kJ/mol and k at 1 1/s while FIG. 10 is a graph 1000 illustrating a determined temperature at point A and point B of the sample 308 with parameter values of Hᵣₓₙ is 200 kJ/mol and k is 0.5 1/s.

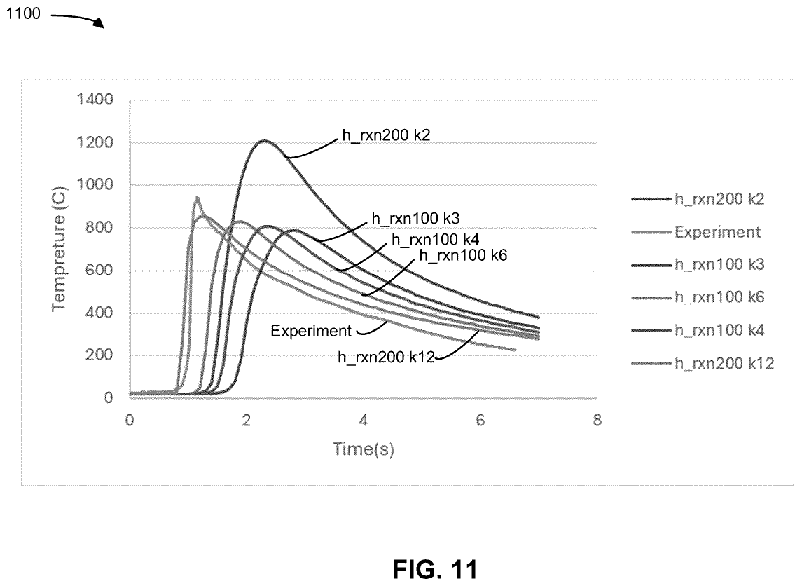

FIG. 11 illustrates a comparison 1100 of results from the thermal propagation model executed with parametric sweeps discussed above as compared with an experimental result. As shown in graph 1100, the cooling phase of the experimental results does not align well with the model predictions. This discrepancy indicates that, under experimental conditions, there is significantly more heat dissipation occurring through convection and radiation than what the model currently accounts for. As a result, the cooling curve in the experiment exhibits a steeper slope, reflecting a more aggressive heat loss than the model predicts.

To address this issue, the heat convection coefficient in the model may be increased to 120 [W/(m\hat{ }2*K)]. By enhancing the convection parameters, the actual cooling dynamics observed during the experimental results can be better simulated. This adjustment allows the model to more accurately reflect the heat transfer processes, leading to improved alignment between the experimental data and the model predictions. Additionally, refining the radiation calculations may be used to further capture the effects of heat loss in real-world conditions. Experimentally, the cathode of the sample typically separates from the underlying current collector during thermal propagation. The separation likely allows for convective cooling on the back side of the cathode layer which may partially explain the high cooling rate that is observed. Natural convection may also be considered for heat dissipation. This is applied as heat flux to the outer boundaries of the system to simulate the natural cooling effect of air. Furthermore, surface-to-ambient radiation may be incorporated across domains to account for the thermal radiation emitted by the surfaces.

### Model Update for k to be Temperature Dependent

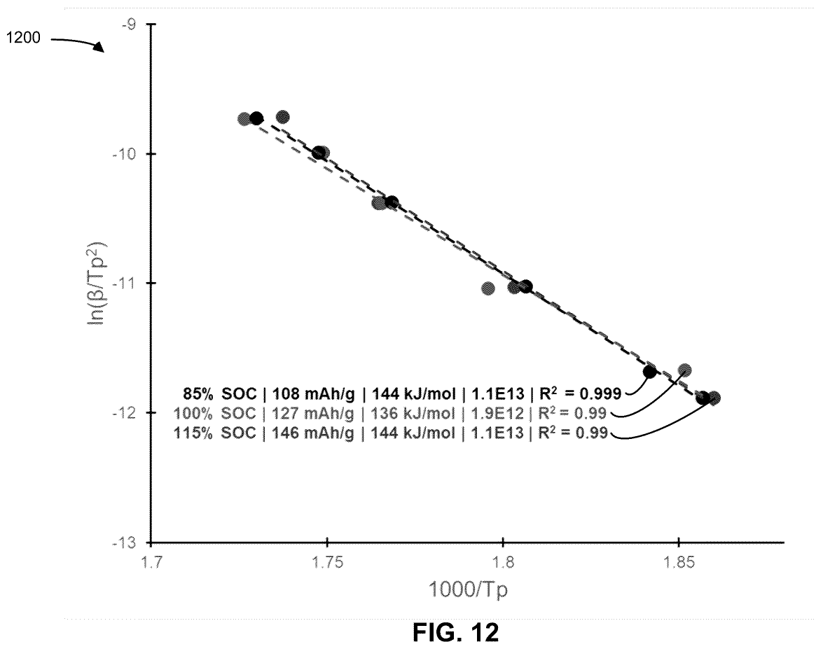

The ideal validation for the arc-lighter model is to use the parameters to then predict the outcome of other abuse tests (e.g. hot box). To apply the results to other abuse tests, the temperature-dependent kinetics are accounted for. The temperature-dependence can be embedded into the kinetic expression as follows:

$$k = Ae \hat{} ( - E\_a / RT )$$

where k [s−1] is the rate constant, A [s−1] is the pre-factor, Ea [kJ mol−1] is the activation energy, R [kJ mol−1 K−1] is the universal gas constant, and T [K] is the temperature. A range of values has been previously determined by DSC fits, as shown in FIG. 12.

The experimental results can be used to guide fitting of the model. In using the Arrhenius relationship, the pre-exponential factor (A) and the activation energy (Ea) become the two fitting parameters. Whereas the universal gas constant (R) is invariant and the temperature (T) is dictated by the local temperature of the finite element.

| | | | R | |
|---|---|---|---|---|
| | | | (kJ mol⁻¹ | |
| | A (s⁻¹) | Eₐ (kJ mol⁻¹) | K⁻¹) | T (K) |
| Value range | 1.9E12-1.1E13 | 136-144 | 0.008314 | Range |
| Note | Fitting range | Fitting range | Constant | Local temp |

A quick calculation at 550 K exhibits a kinetic rate constant that is similar to the fitting of k in the first version of the model:

$$k = Ae \hat{} ( - E\_a / RT ) = 5 \times 10 \hat{} 13 \times e \hat{} ( - 140 / ( 0.008314 \times 550 ) ) = 2.53 s \hat{} ( - 1 )$$

$$where A = 5 E 13 s - 1 and Ea = 140 kJ mol - 1$$

Based on this introduction this equation for k is applied, wherein k is defined as a variable. The variable k may be defined as a min between the above equation and 25 so that k cannot exceed 25 s⁻¹. This prevents numerical instability at high temperatures.

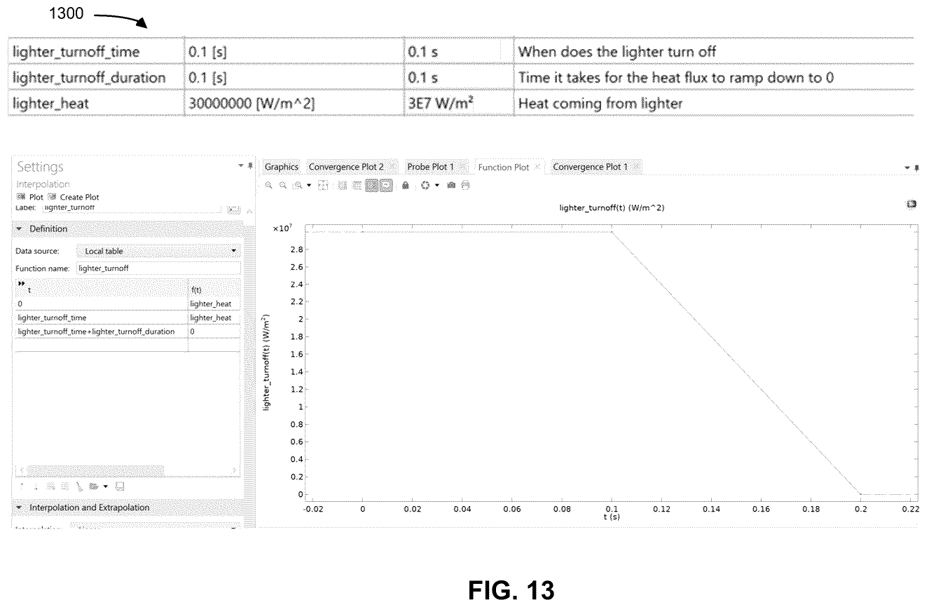

During the simulation, errors arose when the modeled lighter was kept operating. Initially, it is observed that simulation allowed for the lighter to remain lit throughout the simulation, although it was turned off after the onset of the runaway event in the real-world demonstration. To enhance the accuracy of the model, an update is implemented that would turn off the lighter immediately following onset of the runaway, as illustrated in the screenshot 1300 of FIG. 13. In this example, the lighter source is turned off 0.1 sec after ignition. Additionally, the lighter's role is reworked within the simulation to function as a heat source rather than maintaining a constant temperature. This adjustment will allow for a more dynamic representation of heat generation, reflecting the fluctuations in temperature that occur in real-life scenarios. By making these modifications, a more realistic and responsive simulation environment is created. Therefore, temperature boundary condition is removed and instead heat profile is added into the parameters and then defined the lighter off function.

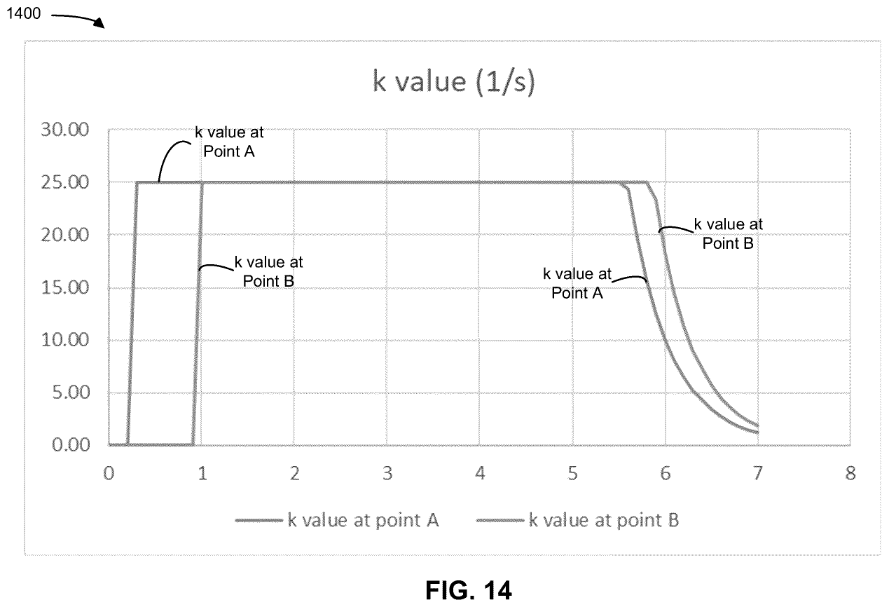

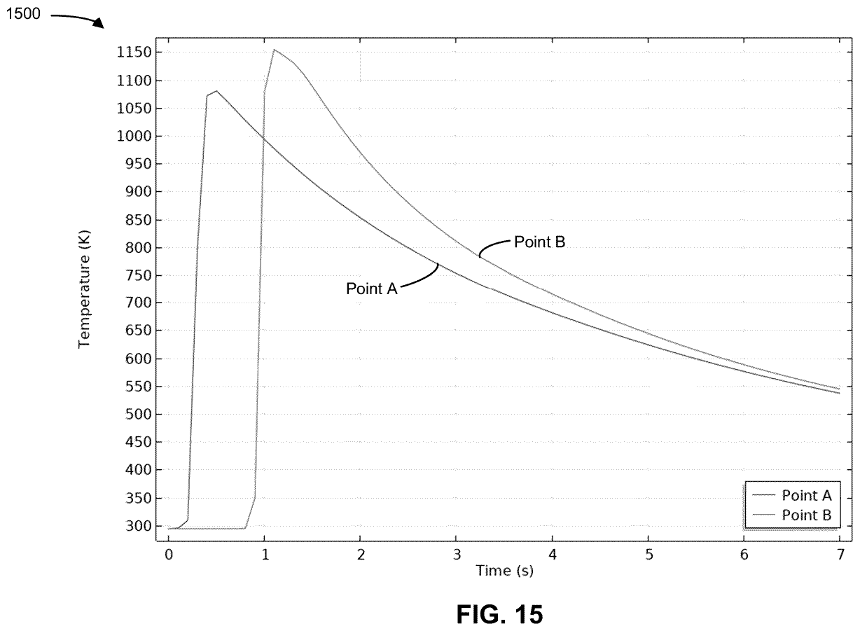

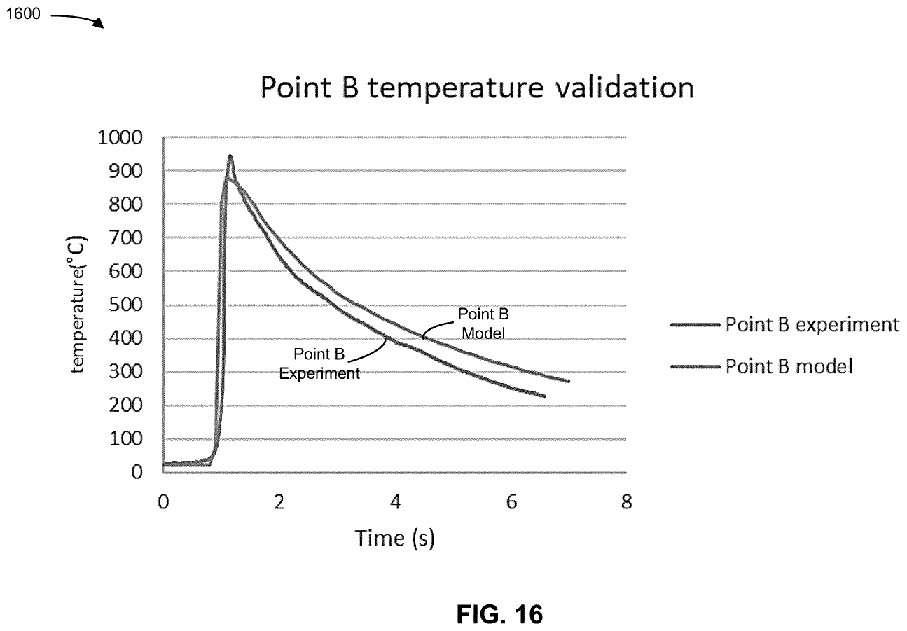

FIGS. 14, 15, and 16 illustrate results of the application of the updates discussed to the model. As shown in the graph 1400 of FIG. 14, k is no longer a constant such that k value is different at point A 110 and point B 106. FIG. 15 is a graph 1500 illustrating point A 110 and point B 106 temperatures for the updated model with Arrhenius equation and lighter off function. FIG. 16 includes a graph 1600 illustrating point B 106 temperature validation for the updated model.

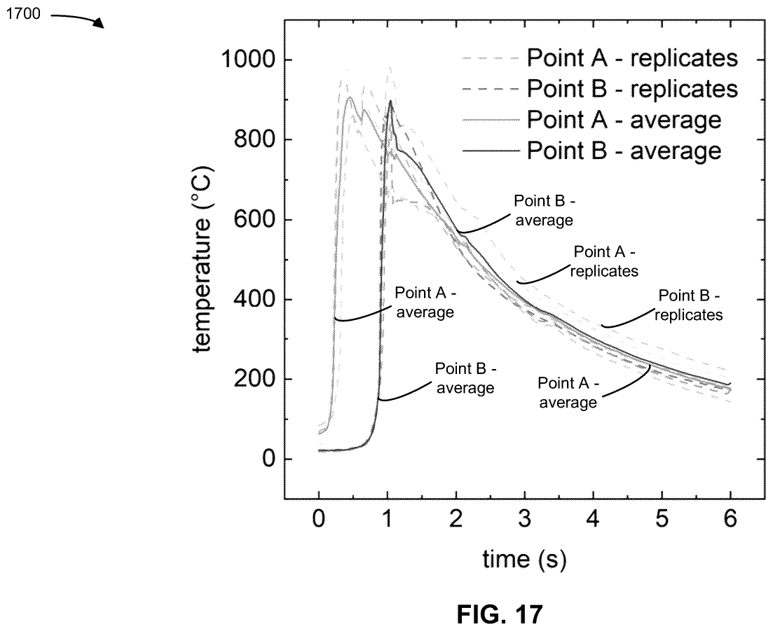

In some instances, experimental datasets may be collected for point A 110 and point B 106 based on the real-world test of the sample 103. The average of these experiments may be generated and used in the model parameter evaluation. For example, FIG. 17 shows the average values for temperature over time for various experiments for point A 110 and point B 106. This experimental data can then be used for parameter estimation, as explained below.

To perform the parameter estimation, the experimental data for point A 110 and point B 106 may be imported into a parameter estimation tool. The parameter estimation tool may allow the model to ingest real-world data for more accurate parameter estimation. It is useful to define the model expressions properly. Specifically, the variable names are set in the parameter estimation tool to match those used in the model. For example, the model expression corresponding to a variable may be specified as comp1.point2, which represents the point probe temperature at point A 110 in the model. This alignment between the experimental data and the model expressions is useful for the parameter estimation process to function effectively. By ensuring that variables and expressions are accurately defined, a smoother estimation process can be facilitated, leading to improved model calibration and better agreement between the model and experimental results.

The parameter estimation process specifies which parameters are to be estimated, along with their initial values. Additionally, upper and lower bounds are defined for these parameters to ensure that the estimation remains within realistic limits. Setting these bounds not only guides the estimation process but also helps in stabilizing the solution and preventing convergence issues. By carefully selecting these values based on prior knowledge or preliminary analyses, a more effective estimation is facilitated that reflects the true characteristics of the system under investigation.

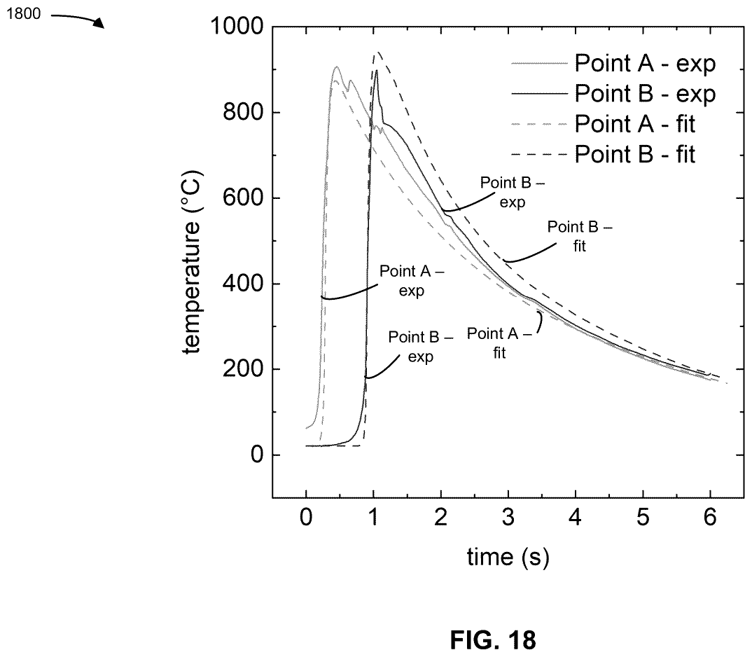

As discussed above, addressing the cooling dynamics improves the model accuracy. In response to this issue, the convection coefficient may be adjusted to 120 [W/(m²·K)]. This modification has yielded a significant improvement in the parameter estimation process, resulting in a much better fit with the experimental data. With this updated convection value, the model now accurately reflects the cooling behavior observed in the experiments, allowing for a more reliable representation of the overall thermal dynamics. FIG. 18 includes a graph 1800 illustrating parameter estimation results and the improvement in the model accuracy.

The mesh can be optimized to enhance the computational efficiency of the model. By refining the mesh design, faster simulation times can be achieved without compromising the accuracy of the results. This may involve adjusting the element sizes and distribution to improve performance across the model. The reliability of the mesh design can be validated by performing a mesh independence analysis. This process can help to determine the sensitivity of the results to mesh size and configuration, ensuring that the findings are not significantly affected by the mesh parameters.

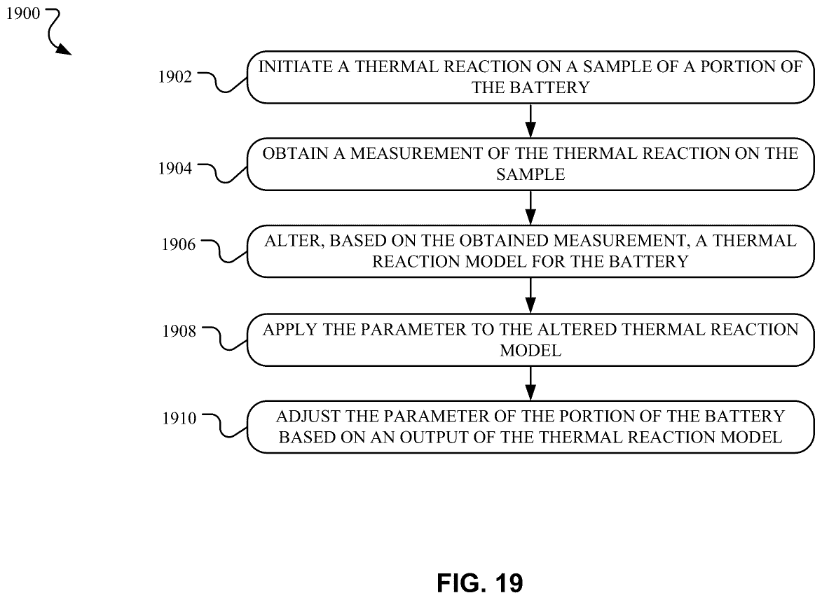

FIG. 19 is a flowchart of an example method for altering a battery component based on a thermal runaway test of a sample of the component and a thermal runaway model according to the present disclosure. Beginning in operation 1902, a thermal reaction on a sample of a portion of the battery may be initiated. In one example, the initiation of the thermal reaction may occur as described above, perhaps utilizing the apparatus illustrated in FIG. 4A. Initiating the thermal reaction thus may include placing the sample in a transparent vessel, extending wires through a sealed port of the transparent vessel to the sample, applying a voltage between the wires to cause a spark at a sample initiating point, the spark causing the thermal reaction, acquiring the measurement of the rate of the propagation of the thermal reaction across the sample, and extracting a sample of gases inside the transparent vessel, after the thermal reaction.

At step 1904, one or more measurements of the thermal reaction on the sample of the portion of the battery may be obtained. In some instances, a camera or other visual capturing device may obtain visual measurements of a rate of propagation of the thermal reaction of at least two points of the sample, as described above. In some instances, obtaining the one or more measurements may include measuring a chemical composition of a gaseous by-product of a combustion of the portion of the battery or measuring a chemical composition of a solid by-product of the combustion of the portion of the battery. Based on the obtained measurements, a thermal reaction model for the battery may be altered or generated at step 1906. The thermal model may be configured to simulate a runaway thermal event to determine a susceptibility of a portion of a battery to thermal runaway.

At step 1908, one or more first parameters of the battery may be applied to the thermal model to determine one or more second parameters of the portion of the battery. The one or more first parameters may correspond to a physical property of the portion of the battery, such as a chemical composition of the portion of the battery, a dimension of the portion of the battery, or a micro-structure of the portion of the battery. The one or more second parameters may correspond to a thermal reaction of the portion of the battery, such as a heat of reaction, an activation energy, or an Arrhenius pre-factor. Based on the one or more second parameters of the portion of the battery from the thermal model, one or more of the first parameters of the portion of the battery may be adjusted. Such adjustment may be determining whether a sheet of material of the portion of the battery is safe to use for manufacturing of the battery.

In some instances, the portion of the battery may be a cathode such that the one or more first parameters comprise a chemical composition of the cathode, a dimension of the cathode, or a micro structure of the cathode. The battery may be, in some instances, an all solid-state battery. In some instances, the portion of the battery may include a portion of an electrode layer comprising at least one of an electrode active material, a conductive additive, a binder, and/or a current collector.

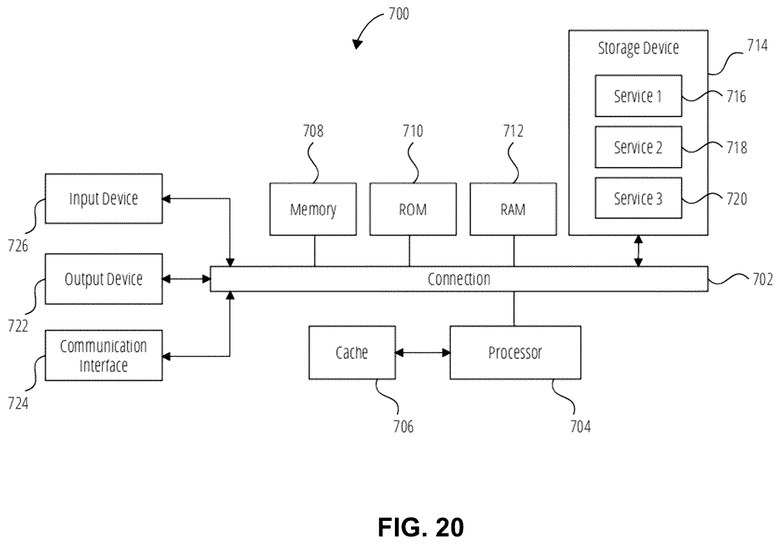

FIG. 20 shows an example of computing system 700, which can be for example any computing device performing the methods and functions disclosed herein or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for analysis of a battery, the method comprising:
obtaining a measurement of a thermal reaction on a sample of a portion of battery, wherein the measurement of the thermal reaction comprises a measurement of a rate of propagation of the thermal reaction of at least two points of the sample;
altering, based on the measurement of the thermal reaction on the sample, a thermal model simulating a runaway thermal event to determine a susceptibility of the portion of the battery to thermal runaway;
applying a first parameter to the thermal model to determine a second parameter of the portion of the battery, the first parameter corresponding to a physical property of the portion of the battery and the second parameter corresponding to a thermal reaction of the portion of the battery; and
adjusting, based on the second parameter from the thermal model, the first parameter of the battery.

2. The method of claim 1, wherein the first parameter comprises at least one of a chemical composition of the portion of the battery, a dimension of the portion of the battery, or a micro-structure of the portion of the battery such that at least one of the chemical composition of the portion of the battery, the dimension of the portion of the battery, or the micro-structure of the portion of the battery is adjusted based on the second parameter from the thermal model.

3. The method of claim 1, wherein the second parameter comprises at least one of a heat of reaction, an activation energy, or an Arrhenius pre-factor.

4. The method of claim 1, wherein:
the portion of the battery is a cathode, the first parameter comprising a chemical composition of the cathode, a dimension of the cathode, or a micro structure of the cathode; and
the battery is an all solid-state battery.

5. The method of claim 1, wherein obtaining measurements of the thermal reaction on the sample of the portion of the battery further comprises measuring a chemical composition of a gaseous by-product of a combustion of the portion of the battery or measuring a chemical composition of a solid by-product of the combustion of the portion of the battery.

6. The method of claim 5, wherein the chemical composition of the gaseous by-product is measured using at least one of Fourier transform infrared spectroscopy, -ray photoelectron spectroscopy, Raman spectroscopy, gas chromatography, nuclear magnetic resonance (NMR), mass spectrometry (MS), or inductively coupled plasma mass spectrometry (ICP-MS).

7. The method of claim 1, wherein the portion of the battery includes a portion of an electrode layer comprising at least one of an electrode active material, a binder, and a current collector.

8. The method of claim 1, further comprising causing the thermal reaction on the sample of the portion of the battery comprising:
placing the sample in a transparent vessel;
extending wires through a sealed port of the transparent vessel to the sample;
applying a voltage between the wires to cause a spark at a sample initiating point, the spark causing the thermal reaction;
acquiring the measurement of the rate of the propagation of the thermal reaction across the sample, and
extracting a sample of gases inside the transparent vessel, after the thermal reaction.

9. The method of claim 1, further comprising:
repeating the obtaining of the measurement of the portion of the battery for a plurality samples that are taken from selected areas of a sheet for manufacturing the battery portion to provide a plurality of measurements; and
determining whether the sheet is safe to use for manufacturing of the battery portion based on an analysis based on the plurality of measurements and on the second parameters.

10. The method of claim 1, wherein applying the first parameter to the thermal model includes performing a parametric sweep that varies one or more variables of the thermal model.

11. The method of claim 1, wherein the thermal model includes a finite element analysis simulation of thermal physics for the thermal runaway.

12. The method of claim 1, wherein the thermal model combines a macro-scale thermal model with an atomic-scale kinetic model.

13. A system for analysis of a battery, the system comprising:
a testing apparatus for causing a thermal reaction on a sample of a portion of the battery, the testing apparatus comprising:
an ignition device for instigating the thermal reaction on the sample; and
a measurement device measuring a rate of propagation of the thermal reaction of at least two points of the sample; and
a computing device comprising a processor and a memory comprising instructions that, when executed, cause the processor to:
alter, based on the measurement of the thermal reaction on the sample, a thermal model simulating a runaway thermal event to determine a susceptibility of the portion of the battery to thermal runaway;
and
apply a first parameter to the thermal model to determine a second parameter of the portion of the battery, wherein the first parameter corresponds to a physical property of the portion of the battery and the second parameter corresponding to a thermal reaction of the portion of the battery,
wherein the first parameter of the battery is adjusted based on the second set of parameters from the thermal model.

14. The system of claim 13, wherein the first parameter comprises at least one of a chemical composition of the portion of the battery, a dimension of the portion of the battery, or a micro-structure of the portion of the battery.

15. The system of claim 13, wherein the second parameter comprises at least one of a heat of reaction, an activation energy, or an Arrhenius pre-factor.

16. The system of claim 13, wherein the testing apparatus further comprises:
a transparent vessel;
a plurality of wires extending through a sealed port of the transparent vessel through which a voltage is applied to cause a spark at a sample initiating point; and
a gas-extraction device extracting a sample of gases inside the transparent vessel, after the thermal reaction.

17. The system of claim 16, wherein the gas-extraction device comprises a balloon.

18. The system of claim 16, wherein the gas-extraction device comprises a syringe.

19. The system of claim 13, wherein the portion of the battery includes an electrode layer comprising an electrode active material, a binder, and a current collector.

20. The system of claim 13, wherein applying the first parameter to the thermal model includes causing the processor to execute a parametric sweep that varies one or more variables of the thermal model.

21. The system of claim 13, wherein the thermal model includes a finite element analysis simulation of thermal physics for the thermal runaway.

22. The system of claim 13, wherein the thermal model combines a macro-scale thermal model with an atomic-scale kinetic model.

23. The system of claim 13, wherein the measurement device is a visual-capturing device comprising a sampling rate and resolution sufficient to capture a plurality of images of the thermal reaction based on the rate of propagation of the thermal reaction across the sample.
